(19) United States
(12) Patent Application Publication
(10) Pub. No.: US 2005/0262719 A1
(43) Pub. Date: Dec. 1, 2005

(54) Device and method for redirecting airflow from a vent to an article

(76) Inventor: Adam Duane Calbreath, Welches, OR (US)

Correspondence Address: GANZ LAW, P.C., P O BOX 2200, HILLSBORO, OR, 97123, US

(21) Appl. No.: 11/042,628

(22) Filed: Jan. 24, 2005

Related U.S. Application Data
(60) Provisional application No. 60/538,550, filed on Jan. 23, 2004.

(51) Int. Cl. F26B 25/00; F26B 7/00

(52) U.S. Cl. 34/239; 34/442

(57) ABSTRACT

The present invention describes device and method for redirecting airflow from a ventilation system, such as that of a vehicle, in order to warm, cool, or dry one or more articles, such as gloves, socks, or the contents of a beverage container. The dryer device comprises a housing comprising an air-capture portion, a body portion, and a nozzle portion. It further comprises an article-attachment system for holding one or more articles on the nozzle and a vent-attachment system for holding the dryer in place on a vent. Because the present invention beneficially exploits a preexisting ventilation system as a convenient source of forced air, it does not require an internal power source, heat source, or blower fan.

### RELATED APPLICATIONS

This application claims priority from U.S. Provisional Application Ser. No. 60/538,550, filed 23 Jan. 2004, the contents of which are hereby incorporated by reference as if recited in full herein for all purposes.

### BACKGROUND OF THE INVENTION

This invention relates to devices for warming or drying articles, such as gloves, socks, caps, and other clothing items. This invention specifically relates to portable warming or drying devices that do not require an internal power source. It was developed after experiencing cold, wet gloves and socks after a vigorous day at the ski slope and is particularly suitable for warming and drying sportswear. Accordingly, to illustrate the principles of the present invention, it will be described in terms of a glove dryer adapted for use inside a motor vehicle. Those skilled in the art will appreciate that the present invention may be used to warm or dry other items and may be used in other contexts and locations.

Conventional approaches for drying gloves, socks, and similar articles include both passive and active dryers. A typical passive dryer provides a supporting structure that holds open a glove or other article to encourage airflow to its inside surfaces. Passive dryers that depend on ambient airflow cannot warm an article above the current temperature, cannot dry it below the local humidity, and may take hours or days to get the job done. Passive devices are almost useless to those shivering in a car after a day on the ski slopes.

A typical active dryer is a stand-alone system that uses an internal heat source and a motorized blower to generate warm air and propel it over or through an article. The heater and blower require a power supply such as a battery or a power cord plus an associated electrical system. An active dryer is faster than a passive dryer but also more complex, expensive, and troublesome. Batteries need routine replacement and may leak dangerous acid that can damage or destroy nearby items. Parts or connections may fail, rendering the dryer useless. Heaters or blowers may break, resulting in shorts, shocks, sparks, or fires. Many active dryers are too large and heavy to be practical in the context of outdoor recreation. And many require 120-volt current, which is typically unavailable at the trailhead, in the parking lot, or while driving. Most active dryers are almost useless to those shivering in a car after a day on the trail or the ski slopes.

A warming and drying device that is simple, portable, convenient, economical, and effective would be a welcome addition to the art. Ideally, it would use forced air to warm and thoroughly dry gloves, socks, and similar items. Ideally, it not require electrical power or other resources not readily available after skiing, hiking, sailing, or other outdoor recreation.

### SUMMARY OF THE INVENTION

In certain aspects, the present invention is a device that redirects airflow from a vent, such as that of a vehicle climate-control system, in order to warm or dry one or more items, such as gloves or socks. Most vehicles have an integrated climate-control system that delivers heated, cooled, or ambient air to the interior of the vehicle through one or more vents. The present invention is a device that attaches to a vent, captures air discharged from the vent, and passes the air over or through one or more items. The present invention thus beneficially exploits a preexisting ventilation system as a convenient source of forced air and uses it to heat or dry an item, for example, an article of clothing.

In an embodiment, the dryer device comprises a housing comprising an air-capture portion, a body portion, and a nozzle portion. The air-capture portion is a flange projecting from the housing and adapted to fit over a vent and adjacent surfaces to form a sufficiently airtight seal. In an embodiment, the air-capture portion may be semi-flexible flange affixed to the housing, so that the flange is a distinct part formed from a pliable material possibly different from that of the housing. In an alternative embodiment, the air-capture portion may be a flared extension of the housing, so that the flange is a continuous portion of the housing. Such embodiments may rely on, for example, a pliable gasket affixed to the contact surface of the flange to aid in forming a seal.

The body portion is substantially airtight enclosure that directs air from the air-capture portion to the nozzle portion. Topologically, the body portion is a chamber or tube with the air-capture portion at one end and the nozzle portion at the other end. The body diverts airflow to the nozzle for discharge. The amount of extension and the angle of discharge are variable aspects of the body. It may be a compact enclosure, so that the entire dryer device remains near the vent. Alternatively, the body may further comprise a tube-like extension, optionally flexible, so that the nozzle portion and the article to be dried may be moved to a convenient place.

The nozzle portion is a generally tubular extension of the housing that discharges air over or through an attached article or articles. The nozzle has an intake aperture where it originates on the body and at least one discharge aperture open to the air. The open end of the nozzle accepts one or more articles to be dried. After securing an article to the nozzle, air redirected through the nozzle passes over or through the article, thereby warming and drying it. In an embodiment, the nozzle has a single discharge aperture. In another embodiment, the nozzle has a plurality of discharge apertures to facilitate drying more than one article at a time. For example, the dryer may have a bifurcated nozzle with two discharge apertures to dry two articles (such as a pair of gloves) at once. In another embodiment, the nozzle may further comprise a tube-like extension, optionally flexible, so that the nozzle discharge portion and the article to be dried may be moved to a convenient place.

To hold the article to be warmed or dried in place on the nozzle, the dryer provides an article-attachment system. Any device or method that can releaseably hold one or more articles on the nozzle is a suitable article-attachment system. In an embodiment, the article-attachment system comprises one or more drawstrings, each with a cord lock. Each drawstring holds an article or articles tight on the center portion of the nozzle. To dry a glove, for example, the open end of the glove is slipped over the open end of the nozzle. The drawstring is then slipped over the glove to form a noose around the glove and nozzle. Pulling the slack out of the drawstring constricts the glove tight against the nozzle for drying. Activating the lock preserves the tension on the drawstring to hold the article in place in place until dried. Releasing the lock loosens the drawstring, allowing the article to be pulled off the nozzle.

In another embodiment, the article-attachment system may comprise a possibly elastic band that can encircle the article and nozzle to hold the article on the nozzle by constriction. One or both ends of the band are provided with a closure means to hold the constricting tension. Suitable closure means include knots, hook-and-loop systems, buckle-and-hole systems, snap closures, magnetic closures, and adhesive closures. In another embodiment, the article-attachment system may comprise a closed elastic band adapted to constrict the article on the nozzle. In another embodiment, it may comprise a releasable clamp. Any of these embodiments may additionally provide a loss-prevention means such as a cord to secure the belt or band to the dryer device. Those skilled in the art will appreciate that many other closure means and loss-prevention means are suitable for this particular purpose.

To hold the dryer in place on a vent, and to provide enough pressure for the air-capture portion to form a seal, the dryer includes a vent-attachment system. In an embodiment, the vent-attachment system comprises at least one tensionable cord, a cord lock, and at least one vent catch. Each vent catch releaseably attaches to the vent system, for example, by fitting between two vent slats to form a hook-like releasable clasp. After each catch is in place, pulling the slack out of the cord pulls the flange tight against the vent. Each cord lock is a device that can preserve the tension on the cord to hold the dryer in place on the vent. Releasing the lock loosens the cord, allowing the dryer to pull away from the vent. Releasing the vent catches removes the dryer from the vent.

In another embodiment, the vent-attachment system comprises a Velcro®-type hook-and-loop closure. By affixing the hook portion around the perimeter of the flange on the contact surface and the loop portion to the surfaces surrounding the vent (or vice-versa), the dryer device may be releaseably attached to the vent. Another embodiment replaces the hook-and-loop materials with flexible magnetic strips. In another embodiment, the vent-attachment system comprises a releasable adhesive applied to the flange, vent surfaces, or both. Those skilled in the art will appreciate that many other attachment means are sufficient for this particular purpose.

The present dryer relies on a pre-existing ventilation system, such as that of a vehicle, as a source of warm, forced air. It does not require an internal heat source, power source, battery, or blower. It has no electrical components and no significant moving parts. As a result of its simplicity, it is robust, lightweight, economical, and easy to use and maintain. It conveniently, quickly, and releasably attaches to almost any vent system in almost any vehicle. It is easily adaptable for many applications and most clothing articles. And because it dries by forcing air through an item, it eliminates moisture from the inside out, thus reducing mold, mildew, and odor from the clothing article.

While the present invention is primarily described as a means for drying gloves, it should be understood that the present invention works equally well with many types of clothing, including hats, socks, mittens, balaclavas, scarves, mufflers, goggles, wristbands, headbands, and earmuffs. In addition, the present invention will be described primarily for use in a motor vehicle having a vent system that can heat the interior cabin. The present invention is easily adapted for use in many environments, however, including home use. It is also easily adapted for heating or cooling non-clothing articles, such as, a beverage.

### BRIEF DESCRIPTION OF THE DRAWINGS

FIGS. 1 through 17 show representative embodiments according to the principles of the present invention, wherein similar features share common reference numerals.

FIG. 1 shows a front top-right perspective view of a representative embodiment according to principles of the present invention;

FIG. 2 shows a front bottom-right perspective view of the device of FIG. 1;

FIG. 3 shows a back top-right perspective view thereof;

FIG. 4 shows a back bottom-right side view thereof;

FIG. 5 shows a side view thereof;

FIG. 6 shows a bottom view thereof;

FIG. 7 shows a top view thereof;

FIG. 8 shows a back view thereof;

FIG. 9 shows a front view thereof;

FIG. 10 shows an assembly view thereof;

FIG. 11 shows the device of FIG. 1 in the process of being installed on a climate-control vent of a vehicle;

FIG. 12 shows the device of FIG. 11 after installation, with a glove in place on the nozzle, ready for use;

FIG. 13 shows a perspective view of an alternative embodiment of an air-capture device having a pliable gasket on the contact surface of the flange to aid in forming a seal;

FIG. 14 shows a front view of an alternative embodiment of a nozzle portion with a bifurcated discharge aperture;

FIG. 15 shows a perspective view of alternative embodiment of an article-attachment system, comprising a belt and an article-attachment means;

FIGS. 16A through 16D show a perspective view of various alternative embodiments a vent catch according to the present invention;

FIG. 17 shows an alternative embodiment where the attached article is a beverage holder, so that the dryer device can warm or cool a beverage instead of warming or drying a clothing article; and

FIG. 18 shows an alternative embodiment of the nozzle portion further comprising a flexible, tubular extension to move the discharge aperture and article to be dried to a desired location.

### DETAILED DESCRIPTION OF THE INVENTION

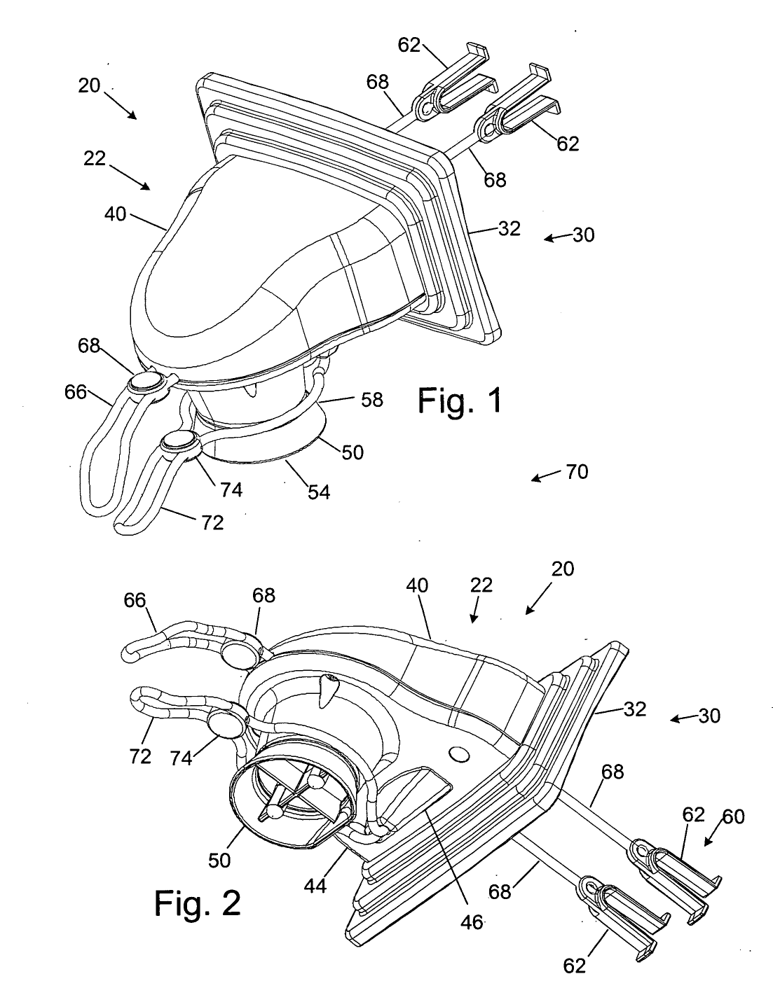

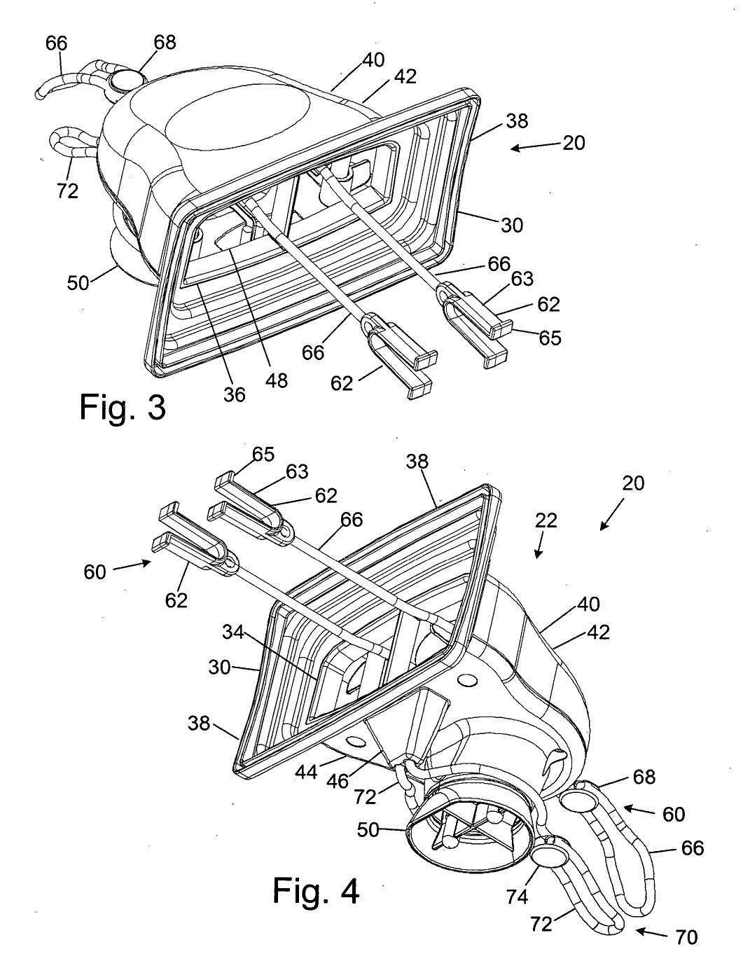

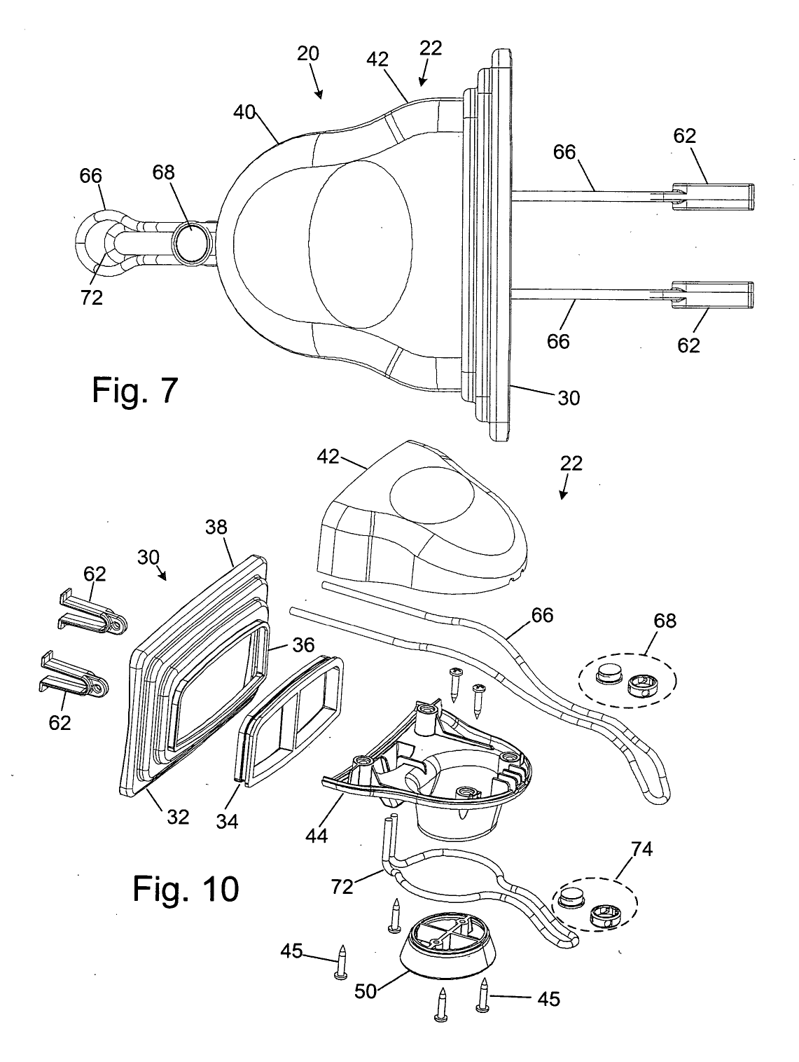

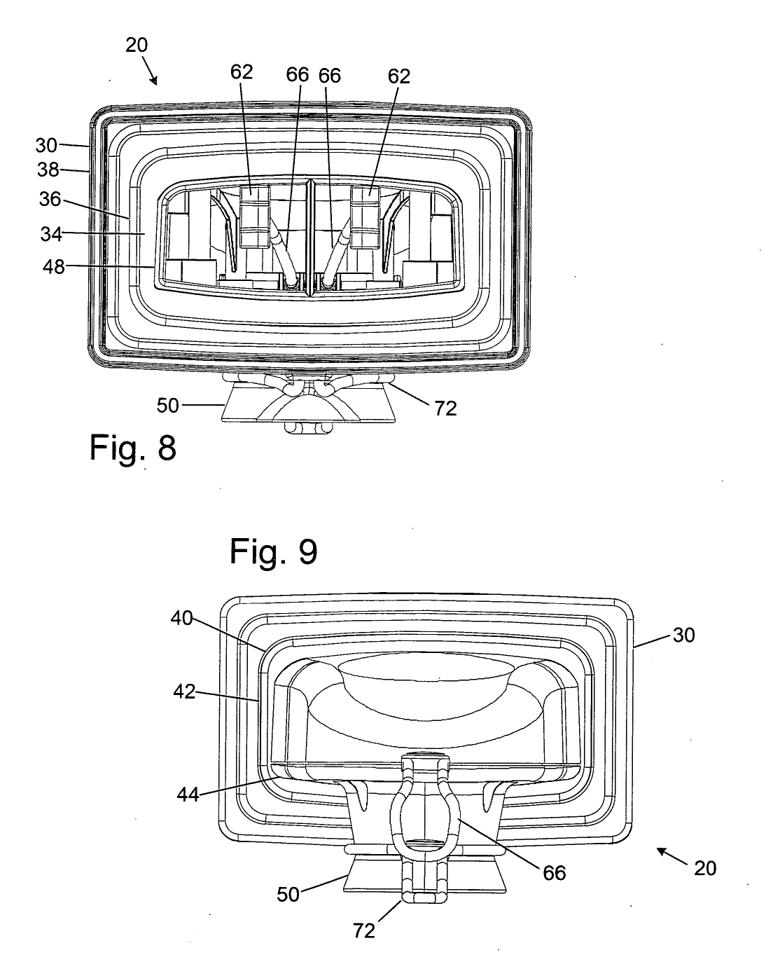

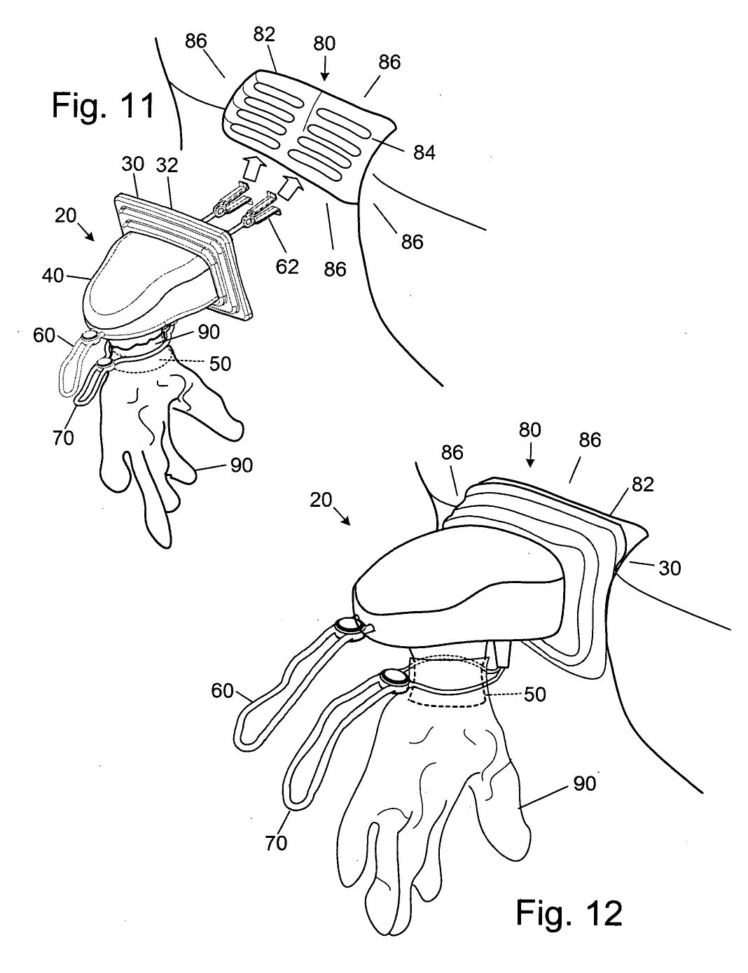

The present invention is directed to devices that warm or dry one or more items—such as an article of clothing, such as a glove—by redirecting airflow from a ventilation system over or through the article. Referring to FIGS. 1 through 10, dryer 20 comprises a housing 22 comprising an air-capture portion 30, a body portion 40, and a nozzle portion 50. Dryer 20 further comprises a vent-attachment system 60 and an article-attachment system 70. Referring also to FIGS. 11 and 12, to mount the dryer, the user pinches together legs 63 of each vent catch 62, pushes catch 62 between slats 84 of vent 82, and releases legs 63, causing prong 65 of catch 62 to catch the interior edges of slats 84. Subsequently tightening vent-attachment system 60 pulls air-capture portion 30 over vent 82 to form a sufficiently airtight seal on surrounding surfaces 86.

Air-Capture Portion

Air-capture portion 30 is a flange 32 projecting from housing 22 and adapted to fit over a ventilation system 80 and to form a sufficiently airtight seal around vent 82. Air-capture portion 30 couples dryer 20 to a preexisting vent 82, so that air expelled from vent 82 passes through dryer 20 instead of directly into the interior of the motor vehicle. Air-capture portion 30 discharges the air into body portion 40; which in turn discharges the air into nozzle portion 50; which in turn discharges the air through the attached article or articles 90. A totally airtight seal is desirable but unnecessary.

Referring to FIGS. 1 thorough 10, air-capture portion 30 has an interior aperture 36 and an outer perimeter 38. Aperture 36 aligns with a corresponding intake aperture 48 of body portion 40 to permit airflow into body 40. Air-capture portion 30 preferably should be sized and shaped to cover the entire vent 82 plus a marginal area on all sides of the vent 82. Accordingly, perimeter 38 preferably should overlap the surfaces 86 surrounding vent 82, such as the adjacent surfaces 86 of a vehicle dashboard, in order to facilitate forming a seal. In the embodiment of FIGS. 1 through 10, perimeter 38 has an approximately rectangular profile, with a length and width selected to equal or exceed the length and width of a typical vent 82. Air-capture portion 30 thus surrounds vent 82 when mounted for use. In other embodiments, perimeter 38 may be circular, square, or polygonal, for example, in order to adapt air-capture portion 30 to fit a vent of a given size and shape.

Air-capture portion 30 should be fabricated at least in part from a pliable or elastomeric material, so that air-capture portion 30 can conform to any curvature or irregularity of the surfaces 86 near the vent 82. In the embodiment of FIGS. 1 through 10, for example, air-capture portion 30 is a semi-flexible flange 32 attached to body portion 40. Any joint, if present, should be substantially air-tight. As shown in FIG. 10, one method for sealing any joints is the use of an internal gasket 34 to assure a tight seal between flange 32 and body portion 40.

A contemplated material for this embodiment of flange 32 is thermoplastic urethane (TPU), selected for its flexibility and toughness over the range of temperatures typically encountered in motor vehicle ventilation systems 80. Other contemplated materials include thermoplastic rubber (TPR), thermoplastic olefin (TPO), thermoplastic elastomer (TPE), silicone, closed-cell foam, open-cell foam, EVA foam, foam rubber, natural rubber, synthetic rubber, polyurethane epoxy, polyurethane polymer (monomer or co-polymer), or any alloy of these materials, alone or in combination. Contemplated fabrication methods include molding, injection molding, direct-injection molding, one-time molding, composite molding, insert molding, co-molding separate materials, foam injection molding, compression molding, thermoforming, rotational molding, blow molding, or other techniques known in the art, alone or in combination.

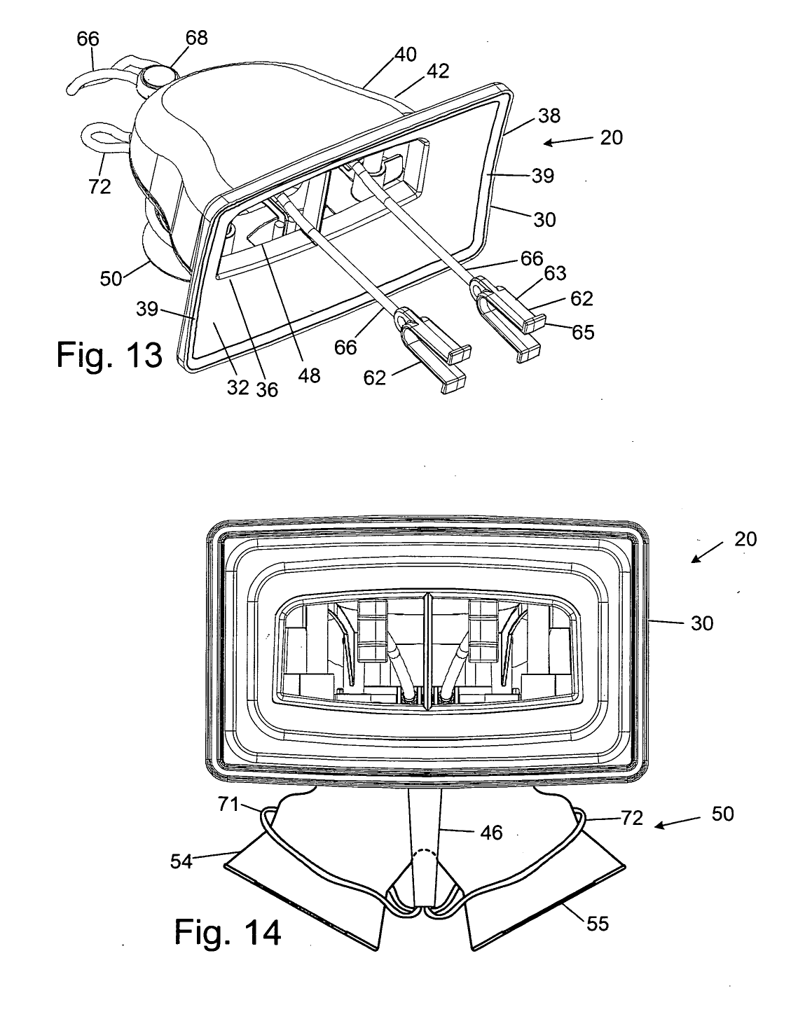

In another embodiment, as shown in FIG. 13, air-capture portion 30 may be formed as a flared extension of housing 22 with a gasket 39 applied to the surface of flange 32 to be pressed against the vent 82. In this embodiment, flange 32 is a continuous portion of housing 22 and typically fabricated simultaneously from the same material and by the same method. Gasket 39 may be fabricated from a cushioning material such as, but not limited to, natural or synthetic felt, cork, foam rubber, or any similar pliable, resilient material, so that gasket 39 forms a seal when pressed against surface 86. Gasket 39 may be affixed to housing 22 by, for example, adhesives.

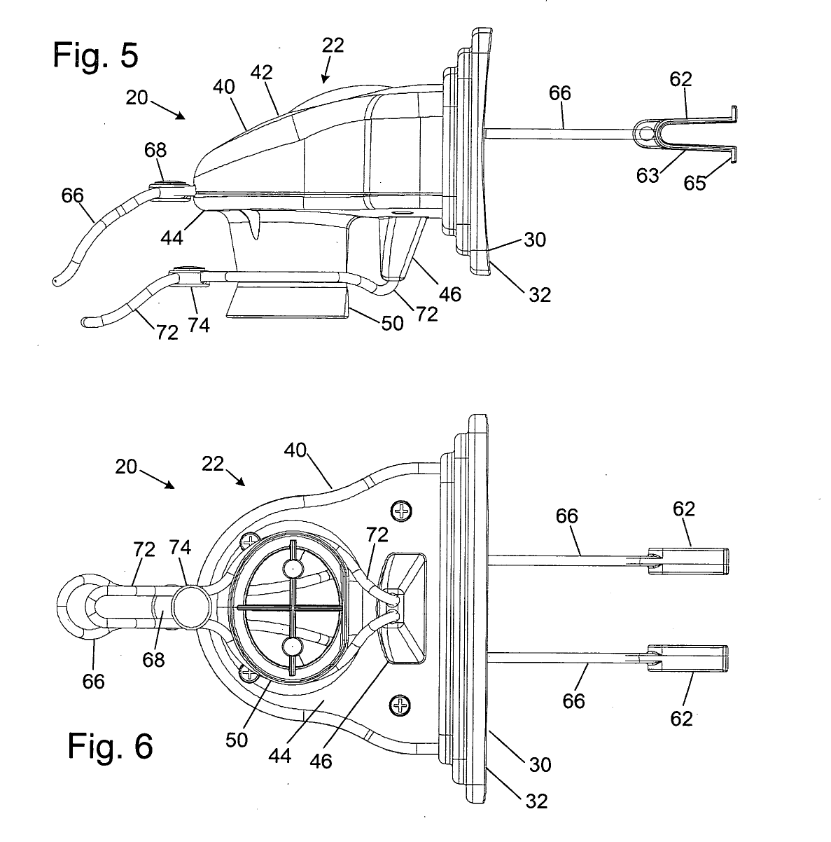

Viewed from the side, air-capture portion 30 may have a profile adapted to facilitate the formation of a seal by approximating the profile of surfaces 86 near vent 82. For example, as best shown in FIG. 5, air-capture portion 30 may have a concave profile, mirroring the horizontally curved surfaces 86 of a typical dashboard. Those skilled in the art will appreciate that variations in the three-dimensional structure of ventilation systems 80 may obligate corresponding adaptations in the three-dimensional profile of air-capture portion 30. The side profile may be flat, convex, concave, or irregular, for example, in order to conform to an anticipated profile of the mating surfaces 86 near the vent 82.

Body Portion

Body portion 40 is substantially airtight enclosure that diverts air from air-capture portion 30 to nozzle portion 50. Topologically, body portion 40 is a chamber or tube with air-capture portion 30 at one end and nozzle portion 50 at the other end. Body portion 40 has an intake aperture 48 aligned with the interior aperture 36 of air-capture portion 30 and an outflow aperture 49 aligned with intake aperture 52 of nozzle portion 50. Body portion 40 consequently redirects airflow captured from a vent 82 to nozzle portion 50 for discharge.

A contemplated material for housing 22, including body portion 40, is Acrylonitrile Butadiene Styrene (ABS), a rigid thermoplastic material selected for its low cost, high impact strength, good abrasion resistance, and ability to form complex three-dimensional shapes. Other possible materials include any moldable polymer (monomer or copolymer), any crystalline or amorphous thermoplastic, polystyrene, styrene acrylonitrile, vinyl, cellulose acetate, polyethylene, polyvinyl chloride, acetyl, acrylic, polyurethane, nylon, polycarbonate, polypropylene, polyphenylene sulfide, or polusylfone, or alloys of any of these materials, alone or in combination. Contemplated fabrication methods include molding, injection molding, direct-injection molding, one-time molding, composite molding, insert molding, co-molding separate materials, foam injection molding, compression molding, thermoforming, rotational molding, blow molding extrusion, or other techniques known in the art, alone or in combination. Persons skilled in the art will recognize that almost any solid material that can be formed into an enclosure is suitable for producing housing 22. Metal, for example, formed by stamping or casting, for example, would be just as practical as the plastic materials listed.

For convenience during manufacturing, housing 22 including body portion 40 may be configured as a continuous unit or assembled from multiple parts. For example, air-capture portion 30, nozzle portion 50, or both may be continuous extensions of body 40, formed at the same time from the same material; or either may be a separate part, formed from a possibly different material and a possibly different method than body 40. FIG. 10 shows an exploded view of a representative embodiment where body 40 is fabricated by assembling a cover 42 and a base 44 by means of fasteners 45. These enabling details are not intended to limit dryer 20 or body 40 to the particular parts and configuration shown in FIG. 10. Persons skilled in the art will recognize that many modifications and variations are possible in the details, materials, and arrangements of the portions of dryer 20. Housing 22 and body 40 according to the principles of the present invention may have fewer or more parts, in order to arrive at various designs that are practical for manufacturing.

The amount of extension is a variable aspect of body portion 40. Body 40 may be a relatively compact enclosure, so that the entire dryer 20 remains near the vent 82, as shown in FIGS. 1 through 10. Alternatively, body 40 may be tube-like extension, optionally flexible, so that nozzle 50 and article 90 may be moved to a convenient place. Optionally, an attachment catch or similar device may be provided to affix nozzle 50 and article 90 where desired.

Nozzle Portion

Nozzle portion 50 is a generally tubular extension of housing 22 that discharges air over or through a glove or similar article. Nozzle portion 50 has an intake aperture 52 joined to body 40, a discharge aperture 54 open to the air, and a center portion 56, preferably with a constriction 58. Nozzle 50 is adapted to support one or more articles 90 to be warmed or dried. To dry a glove, for example, the user inserts discharge aperture 54 concentrically inside the open end of the glove. The user then employs article-attachment system 70 to secure the glove to nozzle 50 at constriction 58 as detailed below.

Nozzle portion 50 may be a continuous extension of housing 22 or assembled from one or more parts attached to housing 22 at outflow aperture 49 of body 40. Any joint, if present, should be substantially air-tight.

A contemplated material for nozzle 50 is ABS, a rigid thermoplastic material selected for its low cost, high impact strength, good abrasion resistance, and ability to form complex three-dimensional shapes. Alternative materials include all those listed above for body portion 22. Contemplated fabrication methods include all those listed above for body portion 22. Persons skilled in the art will recognize that almost any solid material that can be formed into an open-ended tube is suitable for producing nozzle portion 50. Metal, for example, formed by stamping or casting, for example, is just as practical as the plastic materials listed.

The angle between body 40 and nozzle 50 is a variable aspect of the present invention. FIGS. 1 through 10 show an embodiment with a fixed angle of about ninety degrees with respect to the major axis of housing 22. Any fixed or variable angle is within the scope of the present invention, however. A variable angle may be accomplished by introducing a hinge-like pivot on nozzle 50.

FIGS. 1 through 10 show an embodiment where nozzle portion 50 has a single discharge aperture 54. In another embodiment, nozzle 50 may have a plurality of discharge apertures so that the dryer can dry more than one article 90 at a time. For example, as shown in FIG. 14, nozzle 50 may have a bifurcated nozzle 50 with first discharge aperture 54 and a second discharge aperture 55 in order to dry two articles (such as a pair of gloves) at the same time. Adapting nozzle 50 for more than one discharge aperture may require adapting the article-attachment system 70. For example, the embodiment of FIG. 14 has a first drawstring 71 for first discharge aperture 54 and a second drawstring 72 for second discharge aperture 55.

In another embodiment, as shown in FIG. 18, nozzle portion 50 may further comprise an optionally flexible, tube-like extension 53 so that discharge nozzle 54 and article 90 may be moved to a convenient place. Optionally, an attachment catch 59 or similar device may be provided to affix nozzle 50 and article 90 where desired. Optionally, a loss-prevention means 73 attaches to drawstring 72 or belt 76 and to body 22, thereby reducing the risk of loss of drawstring 72 or belt 76.

In certain embodiments, nozzle portion 50 is adapted to hold a glove or similar item by a tension fit or friction fit as described below.

Article-Attachment System

Article-attachment system 70 holds one or more articles 90 in place on nozzle 50 for warming and drying. Any device or method that can releaseably hold one or more articles 90 on nozzle 50 is a suitable article-attachment system.

Some embodiments of dryer 20 rely on a tension fit or friction fit between nozzle portion 50 and article 90. For example, nozzle portion 50 may have a size and shape predetermined to conform tightly against the inner wrist surface of a glove, so that the slight elasticity of the glove materials suffice to hold the glove in place on the nozzle. In such embodiments, the article-attachment system 70 comprises the configuration of nozzle 50 whereby it achieves a friction fit. Such embodiments may omit additional parts otherwise needed.

In an embodiment, as shown in FIGS. 1 through 10, article-attachment system 70 comprises at least one drawstring 72 with an associated drawstring lock 74. As shown best in FIGS. 5 and 6, drawstring 72 is a filament that loops around the center portion 56 of nozzle 50. On the “rear” side of nozzle 50, the looped portion of drawstring 72 passes through lock 74, which provides a mechanism for holding or releasing tension on drawstring 72. On the “front” side of nozzle 50, both ends of drawstring 72 pass into a protrusion 46 provided on housing 22 to form a closed loop and to prevent the loss of drawstring 72. Methods of creating the loop include any of various knots or crimps known in the art. Protrusion 46 also creates a stand-off distance from its base to its apex in order to generally align the looped portion of drawstring 72 with any constriction 58 of nozzle 50. Attaching article 90 at constriction 58 reduces the risk that article 90 will slip off in use, since the diameter of discharge aperture 54 slightly exceeds that of constriction 58.

The general usage of article-attachment system 70 is to slip an article 90 to be secured over nozzle 50 but under drawstring 72. To dry a glove, for example, the open end of the glove is slipped concentrically over the open end of nozzle 50, so that discharge aperture 54 is inside the “wrist” of the glove. Drawstring 72 is then slipped over the glove to form a noose around the glove and nozzle 50. Pulling the slack out of drawstring 72 holds the glove tight against the center portion 56 of nozzle 50. Activating lock 74 preserves the tension on drawstring 72 to hold article 90 in place in place until warmed or dried. Releasing lock 74 loosens drawstring 72, allowing article 90 to be pulled off nozzle 50.

A preferred material for drawstring 72 is elastic shock cord or similar stretchable cordage materials known in the art. The use of elastomeric cordage improves the gripping power applied by drawstring 72 on article 90 when tightened on nozzle 50. Other contemplated materials for drawstring 72 include synthetic or natural cordage made from, for example, Polypropylene, Nylon, Polyester, or similar fibers.

Drawstring lock 74 may be any of various cord locks or cord clamps known in the art. A typical cord lock is a plastic assembly that traps a drawstring fed through a hole in the lock body against another hole in a spring-driven cylinder. Pinching against the spring tension releases the lock, allowing the drawstring to slip through the holes. Suitable lock types, known in the art, include barrel, elliptical, or ball locks.

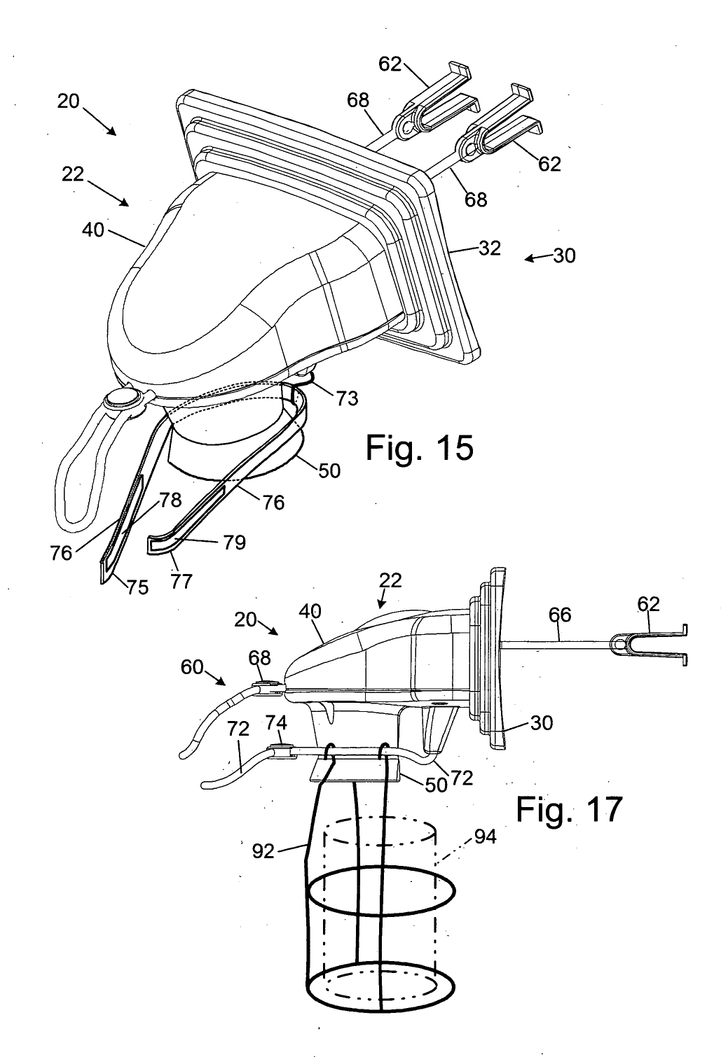

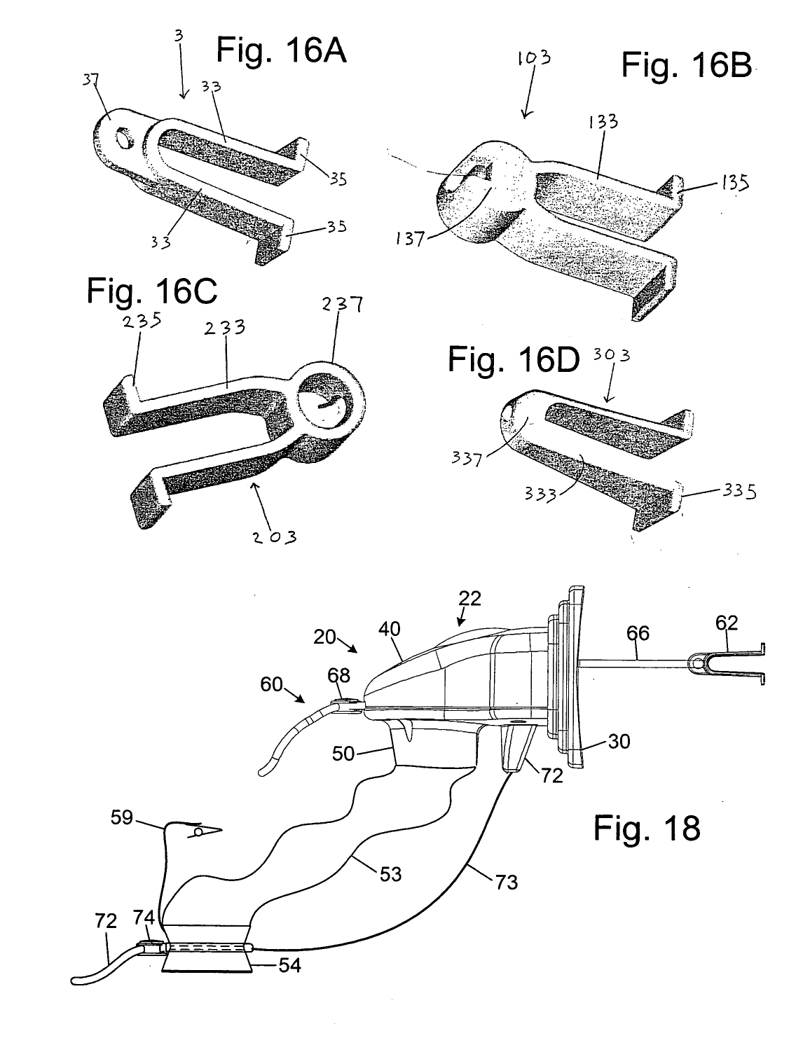

In another embodiment, shown in FIG. 15, article-attachment system 70 may comprise a tensionable belt 76 provided with a closure means 78. Belt 76, sized to wrap around nozzle 50 and article 90, has a first end portion 75 and a second end portion 77. Belt 76 may be fabricated from an elastomeric material, in order to improve the constriction force that holds article 90 on nozzle 50, or from non-elastic material, such as plastic, leather, cloth, or wire. Contemplated attachment means include knots, a hook-and-loop closure means, a buckle-and-hole closure means, a snap-type closure means, a magnetic closure means, and a releasable adhesive closure means.

With the knot closure means, the user wraps the first end portion 75 and second end portion 77 of belt 76 around article 90 and nozzle 50, and then ties a knot between first end portion 75 and second end portion 77 in order to hold article 90 on nozzle 50 by constriction. Representative suitable knots include bag-closure knots such as the Miller's knot. A knot represents an elegant, simple, reliable, and releasable closure means but requires the user to remember an appropriate knot.

In a hook-and-loop closure means, for example Velcro®, shown as an exemplary closure means in FIG. 15, first end portion 75 is provided with the hook part 78 of the closure system, and second end portion 77 is provided with the loop part 79 of the closure system. The user wraps belt 76 tightly around article 90 and nozzle 50, pulls the two ends together with enough tension to constrict article 90 onto nozzle 50, and then presses hook part 78 onto loop part 79, so that hook part 78 adheres to loop part 79. The resulting hook-and-loop closure holds tension on belt 76 and may be readily released to remove article 90.

In a buckle-and-hole closure means, first end portion 75 is provided with a buckle device similar to that found the familiar clothing article called a “belt.” Second end portion 77 has at least one hole, and preferably a longitudinal series of holes, to provide for an adjustable closure system. The general operation of the buckle-and-hole closure means is essentially similar to that of the familiar clothing article called a “belt.”

In the snap-type closure means, first end portion 75 is provided with the male part of the snap system. Second end portion 77 is provided with at least one female snap part, and preferably with a longitudinal series of female snap parts, in order to provide for an adjustable amount of constriction. It is understood that the male and female part relationships may be reversed.

In the magnetic closure means, first end portion 75 is provided with a magnet, preferably in the form of a flexible magnetic strip. Second end portion 77 is provided with a piece of magnetically attractive material. Alternatively, second end portion 77 is provided with a second magnet or magnetic strip, arranging the orientation so that the two magnets or magnetic strips attract each other. The user can then constrict belt 76 around article 90 and nozzle 50 and rely on magnetic attraction to hold together end portions 75 and 77.

In the adhesive-type closure means, first end portion 75, second end portion 77, or both are provided with a releasable adhesive known in the art.

In another embodiment, the article-attachment system may comprise an elastic band, similar to an ordinary, familiar rubber band, adapted to encircle article 90 and nozzle 50, in order to hold the article on the nozzle by constriction.

In another embodiment, the article-attachment system may comprise a clamp adapted to releaseably fit around the article and nozzle. For example, the clamp may resemble a traditional clothespin with jaws sized to wrap around the article and nozzle. Those skilled in the art will appreciate that many other strategies are sufficient for this particular purpose.

Any of these embodiments may be combined with a loss-prevention means for securing the belt 76, elastic band, or clamp to dryer device 20. FIG. 15 shows a representative loss-prevention means 73, in this case comprising a cord with a first end portion attached to housing 22 and a second end portion attached to belt 76. Those skilled in the art will appreciate that many other methods exist for securing one end of a belt to the other end.

In an alternative embodiment, article 90 may comprise a cup holder, can holder, beverage holder, or like device. FIG. 17 shows a representative beverage holder 92 adapted to support a beverage 94 such as a can of a cola drink and hold it in the air stream from nozzle 50, thereby changing the temperature of the beverage. A typical ventilation system is a climate-control system offering either hot air or cold air (“air conditioning”), so such embodiments can either chill or heat beverage 94, depending on the climate-control settings.

Beverage holder 92 is shown in FIG. 17 as an open cage, but other beverage-holder designs are within the scope of the invention. For example, the beverage holder may include an upper cup adapted to fit tightly on nozzle 50 and to feed a manifold that in turn feeds a series of air channels passing though the walls of a enclosed or semi-enclosed cup-like support. Placing a beverage can or cup in the cup-like support places the walls of the beverage can or cup substantially in contact with the air channels, which heat (or cool) the beverage by conduction.

Vent-Attachment System

Vent-attachment system 60 holds the dryer 20 in place on advent 82 and provides enough pressure for the air-capture portion 30 to form a sufficient seal against the surrounding surfaces 86.

In an embodiment, as shown in FIGS. 1 through 10, vent-attachment system 60 comprises one or more tensionable cords 66, one or more cord locks 68, and at least one vent catch 62. Cord 66 is a filament, belt, band, or length of cordage similar to drawstring 72.

In an embodiment, as best shown in FIGS. 4 and 5, cord 66 is directed through body 22 along one path and then looped back through body 22 along a second path. Both ends of looped cord 66 extend in front of body 22, and each end is secured to a catch 62, for example, by using a crimp, knot, splice, or other attachment means.

A contemplated material for tensionable cord 66 is synthetic or natural cordage made from, for example, Polypropylene, Nylon, Polyester, or similar fibers. Polyester cordage in particular has a desirable combination of strength and durability at temperatures likely to occur in vehicle ventilation systems. Polyester cordage is also desirably resistant to rot, stretching, and ultraviolet light.

Cord lock 68 provides a mechanism for preserving or releasing tension on cord 66. As shown, cord 66 passes through lock 68 at the rear of housing 22, where the user can readily tighten or release lock 68. Lock 68 may be any of various cord locks or cord clamps known in the art. The operation and availability of cord locks has been previously described in connection to drawstring lock 74.

Each catch 62 has two flexible legs 63, each terminating with a prong 65. Pinching together legs 63 reduces the distance between prongs 65, permitting a catch 62 to be inserted between two vent slats 84 to form a hook-like releasable clasp. Each respective catch 62 is inserted through a target vent and rests along the backside surface of two adjacent vent slats 84. After the catches 62 are properly located inside vent 82, the looped portion of the cord 66 is pulled tight, causing housing 22, via air-capture portion 30, to rest against surface 86 of the vehicle surrounding the vent. Applying lock 68 to cord 66 temporarily secures dryer 20 in fixed relation to the subject vehicle's ventilation system. Releasing lock 68 loosens cord 66, allowing dryer 20 to pull away from the vent. Releasing the catches 62 removes the dryer 20 from the vent.

Catch 62 may take various forms. In one embodiment, shown in FIG. 13, catch 62 has a rim 64 for securing cord 66. Also, catch 62 has two legs 63, each leg 63 having a prong 65. Legs 63 are designed to work as a compressible hinge-spring so catch 62 may be inserted between two adjacent vent slats 84. Prongs 65 are adapted to hook on the backside of the respective vent slat 84. Thus, when a compressing force is removed, legs 63 rebound to their original position, and prongs 65 catch the backside of the corresponding vent slat 84. A compressing force, for example, may be provided by a user squeezing the legs together between fingers.

In an alternative embodiment of a vent-attachment system 60, only one end of cord 66 extends in front of body 22 and is secured to a catch 62. The other end is directed through body 22 and cord lock 68. The remaining end may remain loose or may be attached to dryer 20 in a convenient place.

Other embodiments of a vent catch for the vent-attachment system are shown in FIGS. 15A through 15D. Each catch 140, 240, and 340 has a means for securing the cord 66, such as a rim 143, 243, and 343. Each catch has a pair of legs 142, 242, and 342, and associated prongs 144, 244, and 344, respectively.

In another embodiment, vent-attachment system 60 comprises a Velcro®-type hook-and-loop closure. By affixing the hook portion of the closure to around the perimeter of the surface of flange 32 that is pressed against vent 82 and affixing the loop portion to the surfaces 86 surrounding the vent (or vice-versa), dryer 20 may be releaseably attached to vent 82.

In another embodiment, vent-attachment system 60 comprises a first magnet, preferable a flexible magnetic strip, affixed around the perimeter of the contact surface of flange 32 where it is pressed against vent 82. Vent-attachment system 60 further comprises a second magnet, preferably a flexible magnetic strip, sized to fit the first magnet (or magnetic strip) and affixed to the surfaces 86 surrounding vent 82 and oriented so that the first magnet attracts the second magnet. Pressing flange 32 against vent 82 so that the first magnet aligns with the second magnet yields a magnetic seal to hold dryer 20 against vent 82.

In another embodiment, vent-attachment system 60 comprises a releasable adhesive known in the art affixed around the perimeter of the contract surface of flange 32 where it is pressed against vent 82. For example, a double-sided adhesive tape would allow attaching the tape to flange 32 while maintaining an exposed sticky side of the tape. Pressing flange 32 and adhesive against surrounding surfaces 86 thereby provides a releasable attachment for vent-attachment system 60. Those skilled in the art will appreciate that many other strategies are sufficient for this particular purpose.

The foregoing embodiments and features are for illustrative purposes and are not intended to be limiting. Persons skilled in the art will appreciate that other embodiments are within the scope and spirit of the foregoing teachings.

Persons skilled in the art will recognize that many modifications and variations are possible in the details, materials, and arrangements of the parts and actions which have been described and illustrated in order to explain the nature of this invention and that such modifications and variations do not depart from the spirit and scope of the teachings and claims contained therein.

1. A device for capturing and directing airflow from a ventilation system, the device comprising:
a housing comprising an air-capture portion, a body portion, and a nozzle portion;
an article-attachment system for securing at least one article to the nozzle portion; and
a vent-attachment system for securing the device to the ventilation system.

2. The device of claim 1 wherein the vent attachment system provides for the device to be readily removable by a user.

3. The device of claim 1 wherein the article-attachment system comprises the nozzle portion, the nozzle portion being adapted to hold a predetermined article by a tension fit.

4. The device of claim 1 wherein the air-capture portion is a semi-flexible flange attached to the housing and adapted to capture sufficient air from the ventilation system to facilitate drying of an article attached to the nozzle portion.

5. The device of claim 1 wherein the air-capture portion is a flared extension of the housing with a pliable gasket affixed to the contact surface and adapted to capture sufficient air from the ventilation system to facilitate drying of an article attached to the nozzle portion.

6. The device of claim 1 wherein the air-capture portion is configured to capture air from a vent of a motor vehicle.

7. The device of claim 1 wherein the body portion is a compact enclosure, so that the dryer remains near the vent.

8. The device of claim 1 where the device includes an adjustable portion for moving an attached article to a desired position within a range of predetermined positions.

9. The device of claim 1 wherein the device is adapted to attach to and direct air flow into a plurality of individual articles.

10. The device of claim 1 wherein the nozzle portion has two or more discharge apertures, for receiving two or more articles to be dried.

11. The device of claim 1 where the nozzle portion has a fixed angle with respect to the major axis of the housing.

12. The device of claim 1 where the nozzle portion has an adjustably variable angle with respect to the major axis of the housing.

13. The device of claim 1 wherein the vent-attachment system comprises a tensionable cord, a vent catch at at least one end of the cord for anchoring to an element of the vent system, and a cord lock for holding or releasing tension on the cord, the system securing the device to the vent system.

14. The device of claim 1 wherein the article-attachment system comprises a tensionable element for holding the article to be dried onto the device.

15. The device of claim 14 where the article-attachment system comprises a tensionable band having a first end and a second end and a closure means that can releaseably attach the first end to the second end.

16. A device adapted to removably attach to a vent of a motor vehicle and direct air from the ventilation system to an attachable article.

17. The device of claim 16 wherein the device comprises a housing that includes a portion for mounting an article of clothing or outerwear in the path of the directed air.

18. The device of claim 17 wherein the mounting portion is adapted to mount a glove.

19. The device of claim 18 wherein the housing includes a nozzle portion over which the glove is placed and attaches.

20. The device of claim 16 wherein the attachable article is a beverage holder that is adapted to route hot or cold air from the ventilation system around a surface of a beverage container placed in the beverage holder to heat or cool the contents of the container.
